(19) United States
(12) Patent Application Publication
(10) Pub. No.: US 2004/0243284 A1
(43) Pub. Date: Dec. 2, 2004

(54) Methods and systems for modifying flash files

(75) Inventors: Deepak Dutta, Peoria, IL (US); Tien Dzung Doan, Morton, IL (US); Connie Jo Keene, Peoria, IL (US); Jerry Dean West, Groveland, IL (US); Michael Duane Flowers, East Peoria, IL (US); Bruce Henry Hein, Torino (IT)

Correspondence Address: Finnegan, Henderson, Farabow,, Garrett & Dunner, L.L.P., 1300 I Street, N.W., Washington, DC, 20005-3315, US

(73) Assignee: Caterpillar Inc.

(21) Appl. No.: 10/446,089

(22) Filed: May 28, 2003

(51) Int. Cl. G06F 15/177

(52) U.S. Cl. 701/1; 709/221

(57) ABSTRACT

A method and system are provided to perform a process of modifying a flash file for a control module that produces control signals for a host system based on executable code in the flash file. In one embodiment the method may include the step of retrieving a compiled flash file including a logic portion and a control data portion that includes at least one data variable located at a target address location in the flash file. The logic portion, when executed by a processor, produces at least one output value based on the at least one data variable. Further, the method may include accessing the target address location in the control data portion of the flash file and modifying the at least one data variable with a new data value such that the flash file is updated without recompiling the flash file. Once the flash file is updated, the method may include programming a memory in the control device with the updated flash file such that the control device executes the logic portion of the flash file to produce the at least one output value based on the new data value of the at least one data variable.

### TECHNICAL FIELD

This invention relates generally to flash file systems, and more particularly to systems, methods, and articles of manufacture for creating and modifying Engine Control Module (ECM) flash files.

### BACKGROUND

An important feature in modem vehicles is the Engine Control Module (ECM). This module includes hardware, software, and/or firmware that is used to manage various vehicle operations. For example, ECMs may be configured to control ignition and/or fuel injection operations, regulate exhaust, assist in braking operations, etc.

An ECM performs these control functions by executing one or more programs stored in an internal memory. Typically, these programs include logic that produces one or more output values used as control signals by various components of a host vehicle. The program logic may access one or more performance maps to determine data values to produce the output values. A performance map is a data relationship between one or more control variables associated with operations of the host vehicle, such as ignition timing, engine RPMs, etc. Each map may include one or more data values for each of many different operating conditions. For example, a performance map may include a relationship of data values (e.g., a mathematical function and corresponding data array) from which the program logic may obtain data values to produce an output signal.

Because ECMs may be implemented in different types of vehicles, a particular ECM may include several different performance maps corresponding to varying load conditions that may be experienced by the vehicle. Further, because vehicle applications and conditions may change, the performance maps may sometimes need to be updated with new control data. For example, a user may operate a vehicle under certain conditions that result in inefficient use of the vehicle's engine. Accordingly, the user may desire to adjust the control data included in one or more performance maps to increase the engine's efficiency. Further, a user may wish to make similar adjustments to an entire fleet of vehicles used by a business entity. Although theoretically, updating the control data in a performance map used by an ECM program may correct some efficiency problems with an engine's performance, conventional ECM systems are typically configured in such a manner that makes modifying the ECM programs difficult and, in some instances, very costly.

The difficulties associated with updating conventional ECM systems may be based on the type of memories used for storing the ECM programs. Typically, ECMs include a programmable memory device, such as an Electrically Programmable Read Only Memory (EPROM) device. EPROMs are programmable non-volatile memory devices that retain their data when power is removed. Although these memory devices provide important fault tolerant operations for ECMs, modifying their contents to update information requires special programming circuits and knowledge of certain program data that may be known only to the developer of the ECM program. Thus, in some instances, a customer may have to enlist the services of the ECM provider to assist the customer in modifying control data in an ECM program. For example, a program developer may have to provide the source code for the ECM program to the customer to enable the customer to recompile the program with new control data. Accordingly, the customer must rely on information provided by the ECM program developer to customize the performance of any vehicles that use these programs.

U.S. Pat. No. 5,138,548 to Kienle addresses the above mentioned problems associated with updating data in conventional ECM systems. Kienle discloses an engine control device that stores a basic program produced by a manufacturer of the device. The basic program includes calculation programs (i.e., logic) and selection programs for selecting control data (e.g., ignition angle) used by the calculation programs to control engine operations. An end user, such as a customer, may provide vehicle-specific control data into an EPROM that is accessible by the basic program. Although Kienle allows a user to add data to an engine control device, the new data may only be stored in spare memory locations left free during an initial storage operation. Further, Kienle requires the calculation and selection programs to be stored in a permanently programmed memory that is separate from the EPROM that stores the control data.

Another problem with conventional ECM systems is the inefficiencies associated with transactions between ECM program developers and data map developers. In these arrangements, a program developer generates engine control logic and compiles the logic into an ECM program. The program developer then sends the compiled ECM program to an outsourced developer tasked with developing performance maps for the ECM program. Once the maps are generated, the outsourced developer may recompile the ECM program with the developed performance maps and provide the recompiled program to the program developer. The program developer may make changes to the logic of the recompiled ECM program based on the performance maps provided by the outsourced developer. The program developer may then again compile the ECM program and send the newly compiled program to the outsourced developer for regeneration of the performance maps. This process may be repeated several times until the ECM control program operates according to desired specifications. Accordingly, not only is the outsourced developer dependent upon the program developer for generating and modifying the performance maps, the multiple interactions between the two developers are very inefficient and increase the transaction costs involved with developing an ECM program.

Methods, systems, and articles of manufacture consistent with certain embodiments of the present invention are directed to solving one or more of the problems set forth above.

### SUMMARY OF THE INVENTION

A method and system is provided to perform a process of modifying a flash file for a control module that produces control signals for a host system based on executable code in the flash file. In one embodiment, the method may include retrieving a compiled flash file including a logic portion and a control data portion that includes at least one data variable located at a target address location in the flash file. The logic portion, when executed by a processor, produces at least one output value based on the at least one data variable. Further, the method may include accessing the target address location in the control data portion of the flash file and modifying the at least one data variable with a new data value such that the flash file is updated without recompiling the flash file. Once the flash file is updated, the method may include programming a memory in the control device with the updated flash file such that the control device executes the logic portion of the flash file to produce the at least one output value based on the new data value of the at least one data variable.

In another embodiment of the invention, a system is provided that includes a first computing system having a memory and a processor being operable to compile source code to develop a flash file used by a control module to produce at least one output value for controlling one or more operations of a host system. The flash file may include a logic portion and a control data portion that defines a data variable used by the logic portion to produce the at least one output value. Further, the system may include a second computing system having a memory and a processor being operable to retrieve the compiled flash file and determine an address location within the flash file corresponding to the data variable. The second computing system may also be operable to update a data value corresponding to the data variable at the address location to create an updated flash file without recompiling the flash file and program the control module with the updated flash file such that the control module produces the at least one output based on the updated data value.

### BRIEF DESCRIPTION OF THE DRAWINGS

The accompanying drawings, which are incorporated in and constitute a part of this specification, illustrate several aspects of the invention and together with the description, serve to explain the principles of the invention.

In the drawings:

FIG. 1 illustrates a block diagram of an exemplary system that may be configured to perform certain functions consistent with embodiments of the present invention;

FIG. 2 illustrates a flowchart of an exemplary base flash file generation process consistent with embodiments of the present invention;

FIG. 3 illustrates a flowchart of an exemplary control data generation process consistent with embodiments of the present invention;

FIG. 4 illustrates a flowchart of an exemplary control data modification process consistent with embodiments of the present invention; and

FIG. 5 illustrates a flowchart of an exemplary flash file modifier process consistent with embodiments of the present invention.

### DETAILED DESCRIPTION

Reference will now be made in detail to the exemplary aspects of the invention, examples of which are illustrated in the accompanying drawings. Wherever possible, the same reference numbers will be used throughout the drawings to refer to the same or like parts.

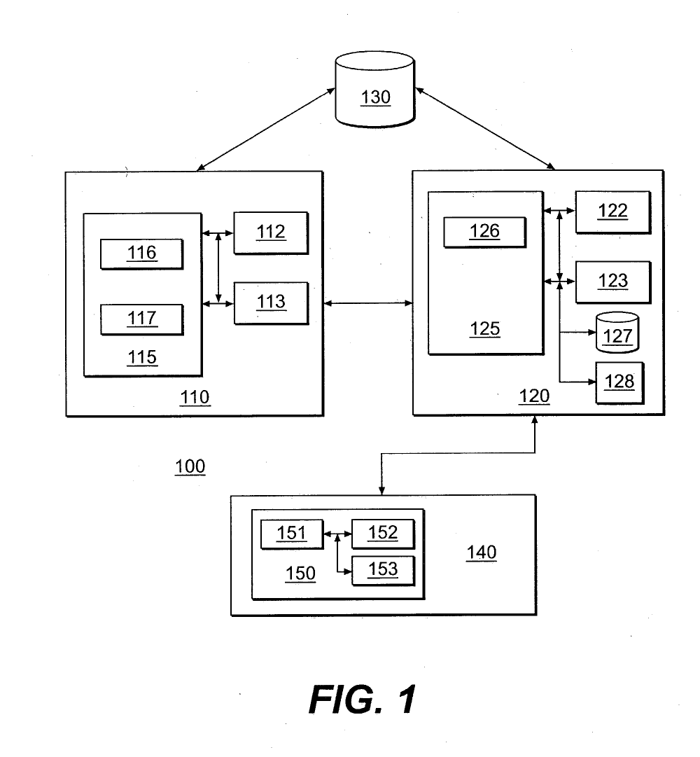

FIG. 1 illustrates an exemplary system 100 in which features and principles consistent with the present invention may be implemented. As shown in FIG. 1, system 100 may include a first computing system 110, a second computing system 120, a database 130, and a host system 140.

First computing system 110 represents a system operated by a user that designs, develops, modifies, and/or tests one or more flash files for an ECM that is implemented within a host system (e.g., ECM 150 included in host system 140). A flash file represents a programmable software file that includes executable control logic and/or control data for an ECM. The control data may include one or more control variables corresponding with one or more components included in host system 140. The one or more control variables are associated with one or more control data values that are related to the one or more components in host system 140. For example, the control data may include performance map data used by ECM 150 to control one or more operating characteristics of host system 140.

First computing system 110 may be associated with a business entity that designs, develops and/or provides flash files to other entities that are affiliated with the business entity (e.g., a subsidiary, division, etc.). Further, first computing system 110 may be associated with a business entity that also designs, develops, and/or provides host systems (e.g., vehicles, machines, manufactured products, etc.) to external entities, such as an external third party vendor, a customer etc. of the business entity.

In one embodiment of the invention, first computing system 110 may be one or more computer systems known in the art, such as a laptop computer, desktop computer, workstation, mainframe, etc. First computing system 110 includes a CPU 112, Input/Output (I/O) interface device 113, and memory device 115. CPU 112 may be one or more processing devices configured to execute program instructions stored in a storage device, such as memory 115. I/O device 113 represents one or more interface devices that facilitate the transfer of information between first computing entity 110 and one or more external components, such as second computing system 120.

Memory 115 represents one or more storage devices including software and/or data used by CPU 112 to perform one or more processes, such as operating system software, application software, etc. In one embodiment, memory 115 includes a system builder program 116 that, when executed by CPU 112, generates, modifies, and/or tests one or more flash files used by ECM 150 operating within host system 140. System builder 116 may be executed by CPU 112 in response to one or more commands from a user and/or a software process operating within first computing system 110. For example, a user may use system builder 116 through a user interface (not shown) to create source code for an ECM flash file control program. Additionally, memory 115 may include a flash file compiling and linking program 117 configured to compile and link source code for a flash file, such as source code developed and provided by a user. Compiling and linking program 117 translates the source code into object code and combines the object code and, possibly, user defined program modules, to form an executable flash file program.

Second computing system 120 represents a computing system operated by a user to design, develop, and/or test control data for ECM control programs, such as the ECM flash files compiled by first computing system 110. Second computing system 120 may be one or more computer systems known in the art, such as a laptop computer, desktop computer, workstation, mainframe, etc. In one embodiment, second computing system 120 may be associated with the same business entity associated with first computing system 110. Alternatively, second computing system 120 may be associated with a different business entity than the business entity associated with first computing entity 110. For example, second computer system 120 may be associated with an entity that purchases components produced by the business entity associated with first computing system 110.

Second computing system 120 includes a CPU 122, Input/Output (I/O) interface device 123, and memory device 125. CPU 122 may be one or more processing devices configured to execute program instructions stored in a storage device, such as memory 125. I/O device 123 represents one or more interface devices that facilitate the transfer of information between first computing entity 120 and one or more external components, such as first computing system 110 and database 130.

Memory 125 represents one or more storage devices including software and/or data used by CPU 122 to perform one or more processes, such as operating system software, application software, etc. In one embodiment, memory 125 includes a system builder program 126 that, when executed by CPU 122, generates, modifies, and/or tests control data and/or flash files associated with ECM 150. System builder 126 may be executed by CPU 122 in response to one or more commands from a user and/or a software process operating within second computing system 120. For example, a user may interact with system builder 126 through a user interface (not shown) to create one or more performance maps for an ECM control program. Additionally, a user may use system builder 126 to modify one or more performance maps within a flash file developed by first computing system 110 without having to recompile and link the flash file.

Second computing system 120 may also include, or is associated with, a database 127 that stores one or more flash files that have been processed by second computing system 120. Further, second computing system 120 may include an ECM writing tool 128 that includes software, hardware, and/or a combination of both, configured to write one or more flash files into ECM 150 operating within host system 140. ECM writing tool 128 may be controlled by software stored in memory 125 and executed by CPU 122, or may be controlled by software stored in a memory device (not shown) and executed by a processing device (not shown) within tool 128. Further tool 128 may be initiated and controlled by a user and/or a software program executing in second computing system 120. Moreover, ECM writing tool 128 may be a software program included in memory 125 and/or system builder 126 that produces output data that is used to control hardware components that physically perform the programming of one or more flash files into ECM 150.

Host system 140 represents any type of system, machine, device, etc. that is powered by a power producing device (e.g., engine) controlled by a control module, such as ECM 150. For example, host system 140 may represent a vehicle system used to perform construction type services, such as earth moving, plowing, digging, drilling, hauling, etc. Non-limiting examples of these types of vehicles include dump trucks, backhoes, farm machinery, etc. Further, host system 140 may also represent other types of vehicles, such as automobiles, motorcycles, tractor trailer trucks, locomotives, water crafts, underwater crafts, air crafts, and any other type of machine or system that is powered by an engine. Host system 140 may be a system that is developed, manufactured, maintained, sold, and/or provided by a business entity associated with second computing system 120, first computing system 110, and/or a third party entity that purchases and/or receives ECM 150 and/or host system 140 from the business entity associated with first and/or second computing entities 110, 120.

In one embodiment, host system 140 includes ECM 150 that produces one or more output values that control one or more components operating within host system 140, such as brakes, exhaust system components, engine components, etc. ECM 150 may include, but is not limited or restricted to, an EPROM 151, controller 152, and memory device 153. EPROM 151 may be any type of programmable memory device that may be programmed by a programming device, such as ECM writing tool 128. In one embodiment, EPROM 151 is configured to store one or more flash files provided by second computing system 120 that, when executed by controller 152, produce one or more output values for controlling one or more components of host system 140. Controller 152 may be one or more processing devices configured to produce output signals that are provided to the one or more components of host system 140 based on the output values produced by a flash file executed within EPROM 151. Controller 152 may also use software and data stored within memory 153 to control and/or perform other types of engine and/or vehicle system related functions.

Although FIG. 1 shows the configuration of computing systems 110 and 120 as separate elements, system 100 may be implemented in a number of different configurations without departing from the scope of the present invention. For example, systems 110 and 120 may be combined into a single system that includes software, hardware, and/or a combination of both that perform the same functions as the corresponding functions associated with systems 110 and 120. Alternatively, system 100 may be configured as a distributed system, with modules 110 and 120 distributed in remote locations and interconnected by communication paths, such as Local Area Networks (LANs), Wide Area Networks (WANs), and any other type of network that may facilitate communications and the exchange of information between the modules and/or any other elements that may be implemented by system 100. Also, system 100 may include additional or fewer components than those depicted in FIG. 1 without departing from the scope of the present invention.

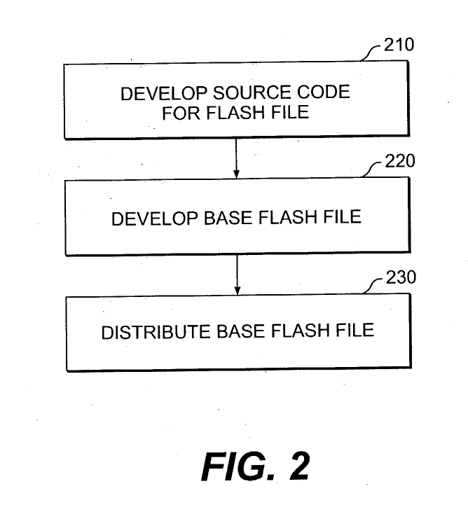

As described, system 100 includes various components that are configured to provide one or more flash files to ECM 150. FIGS. 2-5 show flowcharts of processes that may be performed by one or more components included in system 100.

FIG. 2 shows a flowchart of an exemplary base flash file generation process that may be performed by one or more components of system 100. In one embodiment of the invention, the base flash file generation process is performed by first computing system 110. Initially, a user (e.g., software developer, control engineer, etc.) may develop source code for a flash file that is to be programmed into ECM 150 (Step 210). In one embodiment, the user may invoke system builder 116 to develop the source code through a user interface (not shown). The source code may include logic that, when compiled and executed, is used by ECM 150 to produce the one or more output values for controller 152. The logic may analyze one or more data values of control data to generate an appropriate output value. The source code may or may not include one or more data values associated with one or more control data variables included in the control data. For example. the source code may not include the one or more data values, but rather may define one or more data variables corresponding to the data values. For example, the user may develop logic for an internal combustion engine ECM that instructs ECM to produce an injection flow rate of “Y” when a measured engine RPM is at level “X.” In this example, the data values of “X” and “Y” may not yet be defined by the developer and/or first computing system 110. There may be many different types of logic that are more complex than simple direct relationships, such as the exemplary logic immediately described. For instance, there may be one-to-many and many-to-many data relationships that the logic source code may analyze in order to produce one or more output values.

Once the source code for the flash file is developed by the user, first computing system 110 may compile and link the source code to produce machine language for a base flash file (Step 220). In one embodiment, first computing system 110 may execute the compiling and linking program 117 to perform Step 220. Compiling and linking program 117 may be initialized and executed based on one or more commands provided by the user and/or instructions provided by a software program executing within first computing system 110.

In addition to the base flash file, first computing system 110 may also produce a location file that includes information identifying the address locations of control data that are used by the logic portion of the base flash file. For example, the location file may include one or more address locations of one or more performance maps, values and variables of data associated with each of the maps, configuration information, and data coefficients that are used by the base flash file when executed by ECM 150. In one embodiment, this information (e.g., performance maps, configuration information, and coefficients) may not be developed at this stage of development of the base flash file. Alternatively, the performance maps, configuration data, and coefficient data may have been previously developed and included in the base flash file when it is compiled and linked. Also, first computing system 110 may develop performance map data, configuration data, and/or coefficient data values prior to, during, or subsequent to execution of the base flash file generation process.

First computing system 110 may distribute the base flash file and the location file (i.e., make the file available) (Step 230). In one embodiment, first computing system 110 may first encrypt and compress the compiled base flash file using known encryption and compression techniques and/or software tools. First computing system then stores the compressed flash file in a memory device, such as database 130. Alternatively, first computing system 110 may provide the encrypted and compressed base flash file directly to another component, such as second computing entity 120.

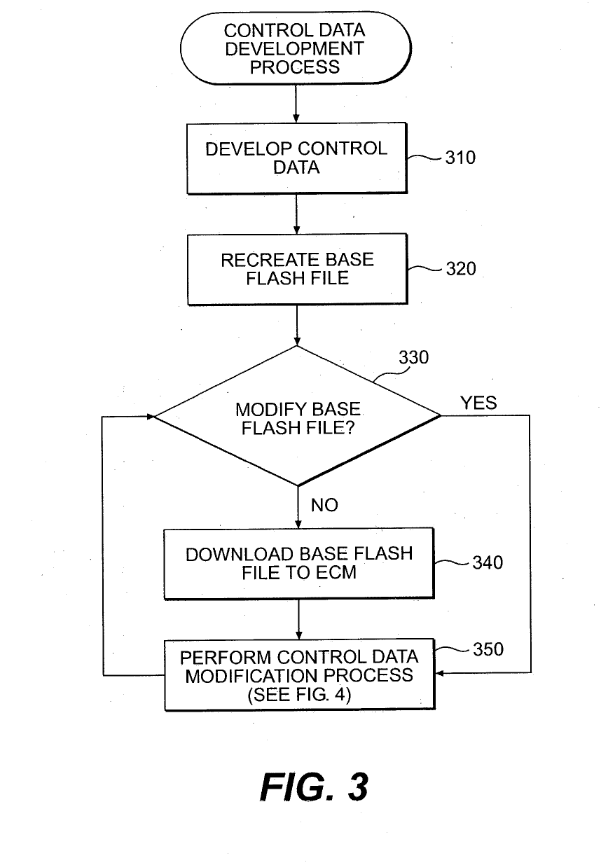

Once the base flash file is distributed, control data for the base flash file may be developed and added to the flash file. FIG. 3 shows a flowchart of an exemplary control data development process that may be performed by one or more components within system 100. In one embodiment, the control development process is performed by second computing entity 120.

Initially, second computing system 120 develops control data for the base flash file complied by first computing system 110 (Step 310). The control data may represent one or more data values corresponding to the control data variables associated with the base flash file compiled by first computing system 110. For example, control data may represent one or more performance maps and their associated data values and/or one or more coefficients or data constants used by the logic included in the base flash file. Further, second computing system 120 may also develop one or more data control variables and their corresponding data values and include them as the developed control data to be used by the logic portion of the base flash file. Second computing system 120 may perform Step 310 prior to, during, or subsequent to, the base flash file generation process described above with respect to FIG. 2. Further, second computing system 120 may perform Step 310 in response to one or more commands provided by a user and/or instructions provided by a software process executing within (or external to) second computing system 120. For example, a user may use second computing system 120 to access the base flash file stored in database 130 to determine one or more data variables in the flash file that require data values. Alternatively, first computing system 110 may provide a list of the data variables directly to second computing system 120 prior to, during, or subsequent to execution of the flash file generation process of FIG. 2.

Once the control data is developed, second computing system 120 may recreate the base flash file with the developed control data (Step 320). In one embodiment of the invention, second computing system 120 may recreate the base flash file using system builder 126. In this step, second computing system 120 invokes system builder 126 and, through this program, accesses database 130 to locate and retrieve the base flash file and corresponding location file developed by first computing system 110. A user or software process may invoke system builder 126 to access database 130 to select and retrieve the base flash file and location file. Once retrieved, system builder 126 accesses the location file to determine the appropriate address locations in the base flash file to insert the control data developed in Step 310. System builder 126 may then insert the data values to recreate the base flash file without having to recompile the file. For example, the location file may include a map of flash file address locations for corresponding control data variables included in the base flash file. System builder 126 may search this map to locate an address location for a corresponding data variable and access the address location in the base flash file to program (e.g., adds, modifies, correlates, etc.) the data value defined by second computing system 120 for that data variable.

In one embodiment, second computing system 120 determines whether the base flash file needs modifications based on the control data inserted in Step 320 (Step 330). The determination may be based on one or more factors associated with the performance of the base flash file when it is executed by a processor. For example, second computing system 120 may perform a test execution of the base flash file to determine whether it performs consistently with predetermined specifications. Second computing system 120 may test the base flash file by using a software test model or an actual test engine corresponding to an ECM model based on ECM 150. Based on the results of the tests, second computing system 120 may determine that the control data defined in the base flash file may need adjusted. If second computing system 120 determines that the base flash file does not require modifications (Step 330; NO), a user or software process (e.g., system builder 126, ECM writing software process, etc.) may invoke ECM writing tool 128 to download the base flash file to EPROM 151 within ECM 150 (Step 340).

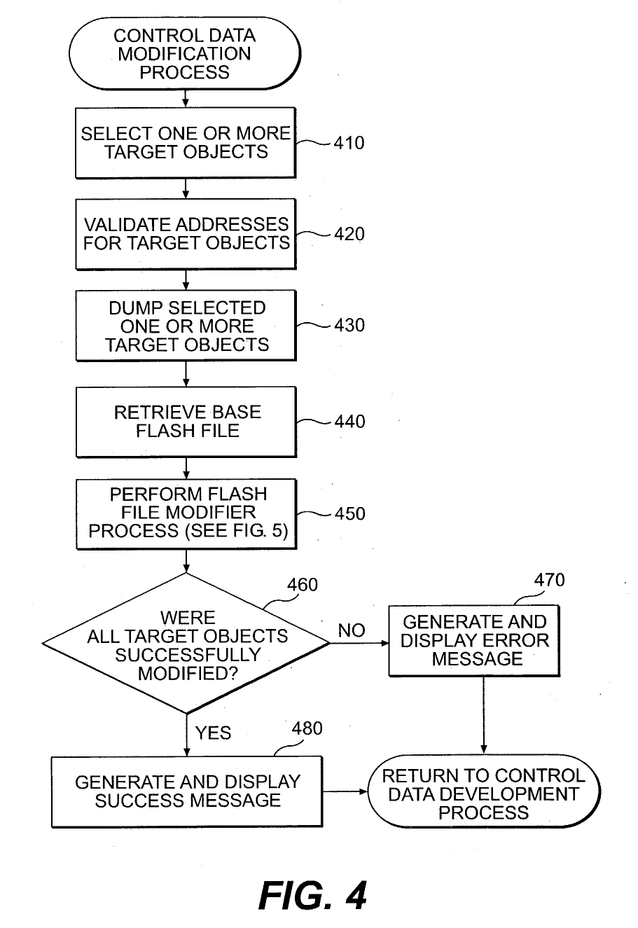

If second computing system 120 determines that some or all of the control data defined in the base flash file requires modification (Step 330; YES), second computing system 120 may perform a control data modification process (Step 350) described with respect to FIG. 4. Once the control modification process has completed modifying the base flash file, the control data generation process returns to Step 330 to determine whether the base flash file requires further modifications.

FIG. 4 shows a flowchart of an exemplary control data modification process consistent with certain embodiments of the present invention. In one embodiment, system builder 126 may provide a user with a list of control data based on the location file corresponding to the base flash file. For example, system builder 126 may generate and display a user interface that presents the list of control data (e.g., performance maps, one or more control variables, one or more data coefficients, etc.) and their corresponding data values (if defined) graphically to the user. The user may select one or more target objects (e.g., control data, such as one or more data variables and their corresponding values for a performance map, coefficients, etc.) from the list. Accordingly, in Step 410, a user (or software process) selects one or more target objects associated with the control data defined in the base flash file. For example, if a user determines that one or more data values within a performance map needs to be changed, the user may select the control data corresponding to these data values as the target objects.

The control data modification process also determines whether each selected target object is associated with a valid address within the base flash file (Step 420). In this step, system builder 126 may retrieve information from the location file to determine the address location of each target object. For example, as described above, the location file may include address locations for corresponding control data variables included in the base flash file. System builder 126 may search this map to locate an address location for a corresponding data variable. If the location file does not include a valid address location for a target object, the control data modification process may automatically update the base flash file with a valid address location for the target object. Alternatively, system builder 126 may generate and provide an error message to the user indicating that the selected target object may not be updated because of an invalid address condition and/or that the target object does not have a corresponding defined variable in the base flash file.

On the other hand, if the control data modification process verifies the address locations of the one or more target objects, the process may dump the selected one or more target objects and/or their corresponding address locations into a target object file stored in a memory device, such as database 127 (Step 430).

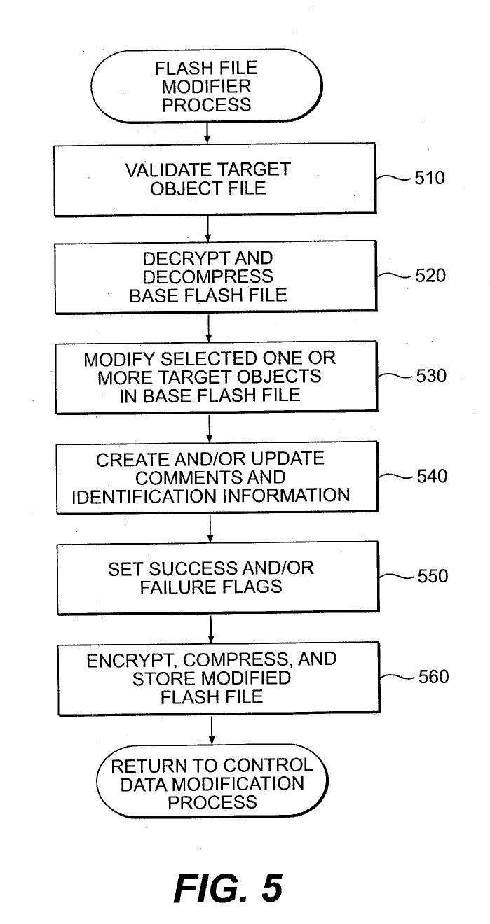

The control data modification process also locates and retrieves the base flash file associated with the selected target objects from database 130 (Step 440). Once the base flash file and the target data objects are accessed, the control data modification process may invoke a flash file modifier process (described below with respect to FIG. 5) that modifies the one or more target objects in the base flash file (Step 450). Upon completion of the flash file modifier process, second computing system 120 determines whether the target objects were successfully modified by the flash file modifier process (Step 460). If one or more of the target objects have not been properly updated (Step 460; NO), second computing system 120 may generate and display an error message indicating the failed attempts in modifying one or more of the target objects selected by the user (Step 470). If, however, second computing system 120 determines that the selected target objects were successfully modified (Step 460; YES), system 120 may generate and display a success message indicating that the base flash file has been successfully updated with the new control data (Step 480). Following the generation of either an error or success message, the control data modification process may return processing back to Step 350 of FIG. 3 of the control data generation process.

FIG. 5 shows a flowchart of an exemplary flash file modifier process that may be performed by second computing system 120. At Step 510, the flash file modifier process collects the target object file from database 127 and checks the validity of the target object file. The flash file modifier process may check the validity of the target object file by ensuring that its format is compatible with the processing capabilities of system builder 126. For example, if the target object file is formatted for use in a particular software application (e.g., Microsoft Word®), the flash file modifier process may check whether system builder 126 is operating under a software platform that is capable of executing and processing files formatted in that application. If the target object file is not compatible with the processing capabilities of system builder 126, the flash file modifier process generates an error message indicating that the target object cannot be accessed and the modifier process ends (Step not shown). Other types of validity checking techniques may be performed by the flash file modifier process ensure the target object file may is valid. For example, the flash file modifier process may compare the object file with a previously stored copy of the target object file to determine whether any information included in the object file has changed. Alternatively, the flash file modifier process may perform an address verification process similar to that performed in Step 420 of FIG. 4. For example, the address verification process may compare the address information associated with each of the target objects with the address information stored in the location file. If a target object is not associated with a valid address designated in the location file, the flash file modifier process may generate an interrupt and provide an error message indicating and identifying the erroneous target object (Step not shown). The flash file modifier process may verify the target object file using different types of data checking operations that are known in the art, such as parity checking, etc., without departing from the scope of the invention.

Referring back to Step 510, if the target object file is valid (e.g., compatible with system builder 126), the flash modifier process decrypts and decompresses the base flash file retrieved from database 130 using known decryption and decompression techniques and/or tools (Step 520). Using the location information included in the location file and/or target object file, the flash modifier process obtains the address locations of each target object that is to be updated in the base flash file. The flash file modifier process then modifies each target object at its designated address location within the base flash file (Step 530). Modifying each target object may include adding (i.e., writing, programming, etc.) a new data value for a corresponding control data variable, erasing an existing data value corresponding to control data variable and replacing it with a new data value, erasing an existing data value corresponding to control data variable, overwriting an existing data value with a new data value, and any other type of memory access operation that manipulates data in the designated address locations. For example, if a target object is associated with an existing data value for a control variable in a performance map, the flash modifier process may determine the address location of the control variable in the base flash file and update the variable's existing data value with a new data value designated by a user (or a software process).

In one embodiment, a user defines the data values for each target object variable through a user interface provided by system builder 126. For instance, system builder 126 may generate a user interface that allows the user to input one or more data values for selected one or more control data variables included in the control data for the base flash file. The user may define the one or more data values prior to, or during, execution of the flash file modifier process. For example, system builder 126 may provide the user interface when the one or more target objects are selected by the user in Step 410 of FIG. 4. Alternatively, system builder 126 may provide the user interface when the flash file modifier process is invoked.

The flash modifier process may also create a backup copy of the base flash file retrieved from database 130 prior to making any changes to the selected one or more target objects. The back up copy of the base flash file may be stored in database 127 or another memory device associated with second computing entity 120. In one embodiment, second computing entity 120 may access and use the backup copy of the base flash file to recreate or continue with target object updates when an error or fault occurs during the flash modifier process. For example, if second computing system 120 experiences a system crash or a software error when writing to an address location within the base flash file, system 120 may execute a fault recovery process that retrieves the backup copy of the base flash file when the flash file modifier process is re-executed. Other types of fault tolerant and recovery operations may be implemented by system 100 to ensure the base flash file is accurately modified.

In one embodiment, the flash file modifier process may also allow the user (or software process) to create and/or update identification information within the base flash file corresponding to the changes made by the modifier process (Step 540). For example, flash modifier process may provide a user interface that enables a user to generate comments and identification information unique to the modified flash file and/or the changes made to the flash file. A user (perhaps a user different from the user that generated the comments and identification information) may use this information to locate and analyze the modified base flash file. That is, a different user may use the identification information to locate the modified base flash file in a directory of modified flash files stored in database 130. Further, the identification information may be used to create a relationship table that lists modifications to the base flash file since its initial compilation by first computing system 110. The user may provide comment information that includes details in user-readable format (e.g., text) of any modification made to the base flash file, including, but not limited to, reasons why the changes were made, the type of changes made, and any relationship the changes have with other modification to the base flash file.

The flash modifier process may also determine whether any target objects that have or have not been properly updated with new data values during the flash file modifier process. Based on this determination, the flash modifier process may set a flag reflecting the success or failure of the one or more of the target object updates (Step 550). For example, the flash modifier process may set a target object success flag for each successful target object update that is performed in Step 530. Once all of the target objects have been updated, or have been attempted to be updated, the modifier process determines whether each target object is associated with a target object success flag. If so, the process sets an update success flag indicating this condition. Alternatively, if the flash modifier process determines that a target object has not been properly updated with new values (e.g., an address error or hardware fault occurs during the modifier process), the modifier process may set a target object failure flag corresponding to the failed target object. Thus, once all of the target objects have been updated, or have been attempted to be updated, the modifier process determines whether each target object is associated with a target object failure flag. If so, the process sets an update failure flag that indicates that one or more target object has not been properly updated, identifies the one or more target objects that are not updated, and identifies the address locations within the base flash file corresponding to these failed target object updates. The update success and failure flags may also be used by the control data modification process to determine whether the selected target objects have been properly updated (e.g., Step 460 of FIG. 4). In addition to flags, the flash file modifier process may implement a counter (software and/or hardware based) that keeps track of how many target object that were or were not properly updated during Step 530. For example, a counter value may be set based on the number of target objects selected by a user in Step 410 of FIG. 4. Each time a successful update occurs for one of those target objects, the flash file modifier process may increment or decrement the counter, depending on how the counting mechanism is implemented (e.g., decrementing or incrementing values). If the counter value is reached during the updating operations, this may indicate to the flash file modifier process that all target objects have been properly updated. Conversely, if one or more target objects have not been properly updated, the counter value may not be reached, thus reflecting one or more failed target object updates.

The flash file modifier process then encrypts and compresses the updated base flash file using known encryption and compression techniques and/or tools, and stores the compressed file in database 127 (Step 560). The flash file modifier process then returns execution of system builder 126 to the control data modification process at Step 460 of FIG. 4.

### INDUSTRIAL APPLICABILITY

Methods, systems, and articles of manufacture consistent with certain embodiments of the invention enable a computing system to create and/or modify compiled flash files for ECMs without having to recompile or link the files. In one embodiment, a first computing entity 110 develops and compiles a base flash file including logic program code associated with an ECM control program for ECM 150. A second computing system 120 retrieves the compiled base flash file and modifies the file with developed control data (e.g., performance maps). The second computing system may update any control data within the base flash file without having to recompile or link the file by using address information in a location file provided by the first computing system 110 when the base flash file is developed. Once second computing system 120 determines that the modified base flash file does not require any more changes (i.e., the file is valid), system 120 may download the modified flash file to a programmable memory device included in ECM 150 operating within a host system 140.

Although host system 140 is described as being associated with a vehicle, system 140 may represent non-vehicle type systems that include a control module that operates similar to ECM 150. For example, host system 140 may represent a non-movable engine powered device that produces output for a manufacturing plant. Host system 140 may also represent a system powered by an ECM controlled engine that performs other non-vehicle type operations, such as an engine driven drilling system on an oil rig. Moreover, host system 140 may represent a test vehicle that is developed and operated for testing purposes. Accordingly, host system 140 is not limited to a system, machine, device, etc. that is provided to a customer, third party vendor, etc, but may be a system, for example, that is developed for testing the efficiency of ECM 150. Further, host system 140 may represent a software model of a host system including ECM 150. In this scenario, host system 140 may represent a software model of a vehicle that provides input to, and receives output from, ECM 150.

Moreover, although embodiments of the present invention are described with respect to engine control systems, embodiments of the present invention may be applied in other types of systems that control other types of machinery and/or components. For example, ECM 150 may represent any type of control module that receives one or more sensor signal inputs to produce one or more output signals for controlling other components in a system, such as environment monitoring systems (e.g., security and/or property monitoring systems), fault tolerant monitoring systems for controlling the operations of another computing system, etc. Accordingly, the control module may include a programmable storage device that stores a flash file control program that is not associated with an engine component or vehicle-based host system.

Also, variations to the sequence of steps described with respect to FIGS. 2-5 may be implemented without affecting the scope of the present invention. For example, the control data generation process described in FIG. 3 may develop control data prior to, during, and/or after receiving and/or collecting the base flash file from database 130. Further, one or more steps described with respect to FIGS. 2-5 may be performed by other processes. For example, second computing entity 120 may generate a back-up copy of the base flash file without executing system builder 126 or the flash file modifier process.

In another embodiment, instead of a user initiating system builders 116 and/or 126, a software process may be executed by a processing device (e.g., CPU 112 or 122) that autonomously invokes, and provides input to, system builder 116 and/or 126. For example, a software routine may be executed by CPU 112 to automatically invoke system builder 116 each time new source code is provided to first computing system 110. Further, system builder 120 may execute compiling and linking program 117 to create the base flash file without input from a user.

In still another embodiment, first and second computing systems 110 and 120 may be associated with a common business entity. For example, operators of first and second computing systems 110, 120 may be employed by different divisions of a common business entity. Further, second computing system 120 may provide a modified base flash file to a third party business entity. The third party business entity may include a computing system that operates similar to second computing system 120. Accordingly, the third party business entity may be capable of modifying any control data within the received flash file without having to rewrite and/or recompile any of the file's source code. The third party business entity may then either provide the flash file to another business entity or may download the file to an ECM or equivalent device. Therefore, embodiments of the present invention may be applied by entities associated with various stages of a product value chain.

Also, although embodiments of the present invention are described with respect to an EPROM device operating within ECM 150, any type of programmable storage device that is compatible with flash files or similar type of programmable files may be implemented. Further, although embodiments of the present invention are described with control data representing performance maps, configuration data, coefficient data, etc., any type of data variables and/or values may be implemented without departing from the scope of the invention. For example, control data may include data variables that may not have a relationship with other data variables associated with characteristics of host system 140.

The embodiments, features, aspects and principles of the present invention may be implemented in various environments. Such environments and related applications may be specially constructed for performing the various processes and operations of the invention. The processes disclosed herein are not inherently related to any particular system, and may be implemented by a suitable combination of electrical-based components. Other embodiments of the invention will be apparent to those skilled in the art from consideration of the specification and practice of the invention disclosed herein. It is intended that the specification and examples be considered as exemplary only, with a true scope of the invention being indicated by the following claims.

What is claimed is:

1. A method of modifying a flash file for a control module in a system including a first computing system and a second computing system, the method comprising:
developing a base flash file at the first computing system, the developing including the steps of:
developing source code for the base flash file,
compiling the source code to develop the base flash file, wherein the base flash file includes at least a logic portion and a control data portion that includes one or more data variables used by the logic portion, and
distributing the base flash file such that the base flash file is accessible to the second computing system; and
modifying the base flash file at the second computing system, the modifying including the steps of:
developing control data values for the one or more data variables in the control data portion of the base flash file,
modifying the base flash file with the control data values without recompiling the base flash file, and
downloading the recreated base flash file to a programmable memory device included in the control module.

2. The method of claim 1, wherein modifying the base flash file with the control data values includes:
selecting a target data variable included in the base flash file;
determining an address location of the target data variable in the base flash file; and
modifying a target data value stored at the determined address location corresponding to the target data variable.

3. The method of claim 2, wherein modifying the target data value includes:
attempting to add a new target data value at the determined address location corresponding to the target data variable; and
generating a message based on whether or not the new target data value is successfully added at the determined address location.

4. The method of claim 1, wherein distributing the base flash file includes:
encrypting the base flash file; and
storing the encrypted base flash file in a database accessible by the first and second computing systems.

5. The method of claim 4, wherein modifying the base flash file at the second computing system includes:
retrieving the encrypted base flash file from the database; and
decrypting the encrypted base flash file.

6. The method of claim 2, wherein developing the base flash file includes:
developing a location file that identifies one or more address locations of the one or more data variables in the base flash file.

7. The method of claim 6, wherein determining an address location of the target data variable in the base flash file includes:
retrieving the address location of the target data variable from the location file.

8. The method of claim 1, wherein the one or more data variables is associated with at least one of a performance map and a data coefficient corresponding to one or more operating characteristics of a host system that uses the control module.

9. The method of claim 1, wherein the first computing system and second computing system are associated with a common business entity.

10. The method of claim 1, wherein the first computing system and second computing system are associated with different business entities.

11. The method of claim 2, wherein selecting a target data variable is performed by a user.

12. The method of claim 1, wherein developing control data values is performed by a user.

13. A method of modifying a flash file for a control module that produces control signals for a host system based on executable code in the flash file, the method comprising:
retrieving a compiled flash file including a logic portion and a control data portion that includes at least one data variable located at a target address location in the flash file, wherein the logic portion, when executed by a processor, produces at least one output value based on the at least one data variable;
accessing the target address location in the control data portion of the flash file;
modifying the at least one data variable with a new data value such that the flash file is updated without recompiling the flash file; and
programming a memory in the control device with the updated flash file such that the control device executes the logic portion of the flash file to produce the at least one output value based on the new data value of the at least one data variable.

14. The method of claim 13, wherein the method is performed by a first computing system and retrieving the compiled flash file includes:
retrieving the compiled flash file from a database that is updated with one or more flash files compiled by a second computing system.

15. The method of claim 13, wherein accessing the target address location includes:
determining the target address location from a location file corresponding to the compiled flash file.

16. The method of claim 13, wherein accessing the target address location includes:
developing a set of data variables for the control data portion of the compiled flash file; and
determining a target address location in the compiled flash file for each of the data variables in the set.

17. The method of claim 16, wherein modifying the at least one data variable includes:
programming a corresponding new data value in each target address location for each of the data variables in the set of data variables.

18. The method of claim 16, wherein determining a target address location in the compiled flash file for each of the data variables in the set includes:
determining the target address locations for each of the data variables in the set from a location file associated with the compiled flash file.

19. The method of claim 18, wherein the location file is created during or following compilation of the flash file.

20. The method of claim 13, wherein the retrieving, accessing, and modifying steps are performed by a software application that receives one or more commands from a user through a user interface.

21. The method of claim 13, wherein the control data portion includes at least one of a performance map and a data coefficient that includes the at least one data variable.

22. A system comprising:
a first computing system having a memory and a processor being operable to compile source code to develop a flash file used by a control module to produce at least one output value for controlling one or more operations of a host system, wherein the flash file includes a logic portion and a control data portion that defines a data variable used by the logic portion to produce the at least one output value; and
a second computing system having a memory and a processor being operable to retrieve the compiled flash file, determine an address location within the flash file corresponding to the data variable, update a data value corresponding to the data variable at the address location to create an updated flash file without recompiling the flash file, and program the control module with the updated flash file such that the control module produces the at least one output based on the updated data value.

23. A system for modifying a flash file for a control module including a first computing system and a second computing system, the system comprising:
means for developing a base flash file at the first computing system, the means for developing including:
means for developing source code for a logic portion of the flash file,
means for developing the base flash file by compiling the source code, wherein the base flash file includes at least a compiled logic portion and a control data portion that includes one or more data variables used by the logic portion, and
means for distributing the base flash file such that the base flash file is accessible to the second computing system; and
means for modifying the base flash file at the second computing system, the means for modifying including:
means for developing control data values for the one or more data variables in the control data portion of the base flash file,
means for modifying the base flash file with the control data values without recompiling the base flash file, and
means for downloading the recreated base flash file to a programmable memory device included in the control module.

24. A system for modifying a flash file for a control module that produces control signals for a host system based on executable code in the flash file, the system comprising:
means for retrieving a compiled flash file including a logic portion and a control data portion that includes at least one data variable located at a target address location in the flash file, wherein the logic portion, when executed by a processor, produces at least one output value based on the at least one data variable;
means for accessing the target address location in the control data portion of the flash file;
means for modifying the at least one data variable with a new data value such that the flash file is updated without recompiling the flash file; and
means for programming a memory in the control device with the updated flash file such that the control device executes the logic portion of the flash file to produce the at least one output value based on the new data value of the at least one data variable.

25. The system of claim 24, wherein the means for accessing the target address location includes:
means for determining the target address location from a location file corresponding to the compiled flash file.

26. The system of claim 24, wherein the means for accessing the target address location includes:
means for developing a set of data variables for the control data portion of the compiled flash file; and
means for determining a target address location in the compiled flash file for each of the data variables in the set.

27. The system of claim 26, wherein the means for modifying the at least one data variable includes:
means for programming a corresponding new data value in each target address location for each of the data variables in the set of data variables.

28. The system of claim 26, wherein the means for determining a target address location in the compiled flash file for each of the data variables in the set includes:
means for determining the target address locations for each of the data variables in the set from a location file associated with the compiled flash file.

29. The system of claim 28, wherein the location file is created during or following compilation of the flash file.

30. The system of claim 24, wherein the control data portion includes at least one of a performance map and a data coefficient that includes the at least one data variable.

31. A computer-readable medium including instructions for performing a method, when executed by a processor, of modifying a flash file for a control module that produces control signals for a host system based on executable code in the flash file, the method comprising:
retrieving a compiled flash file including a logic portion and a control data portion that includes at least one data variable located at a target address location in the flash file, wherein the logic portion, when executed by another processor, produces at least one output value based on the at least one data variable;
accessing the target address location in the control data portion of the flash file;
modifying the at least one data variable with a new data value such that the flash file is updated without recompiling the flash file; and
programming a memory in the control device with the updated flash file such that the control device executes the logic portion of the flash file to produce the at least one output value based on the new data value of the at least one data variable.
